(19) United States
(12) Patent Application Publication
(10) Pub. No.: US 2004/0020012 A1
(43) Pub. Date: Feb. 5, 2004

(54) Self-contained hinge for flip-style device

(76) Inventor: Sheel A. Gupte, Buffalo Grove, IL (US)

Correspondence Address: GREER, BURNS & CRAIN, LTD., Suite 2500, 300 South Wacker Drive, Chicago, IL, 60606, US

(21) Appl. No.: 10/427,682

(22) Filed: Apr. 30, 2003

Related U.S. Application Data
(60) Provisional application No. 60/400,831, filed on Aug. 2, 2002.

(51) Int. Cl. E05F 1/08

(52) U.S. Cl. 16/303

(57) ABSTRACT

A self-contained hinge is disclosed for use in a flip-style device, such as a personal digital assistant (PDA). The spring provides a compressive force to maintain the cam pressed against the follower. Additionally, the spring applies a torsional force to the cam to facilitate rotation of the follower relative to the cam and automatically open the hinge.

### CROSS-REFERENCE TO RELATED APPLICATIONS

The present Application claims priority under Title 35 U.S.C. §119 on copending Provisional Patent Application Serial No. 60/400,831, filed Aug. 2, 2002.

### FIELD OF THE INVENTION

The field of the invention is flip-style devices, for example personal digital assistants (PDA's) and cell phones. More particularly, the invention relates to hinges for such flip-style devices.

### BACKGROUND OF THE INVENTION

Due to size and aesthetics, flip-style housings are popular for a wide range of small portable devices, such as PDA's and wireless devices, e.g., cell phones. A flip-style device generally requires a hinge connecting a main part and a flip part of the device. Commonly, it is desirable for the hinge to provide initial resistance to movement of the flip part from either a fully open or a fully closed position of the flip-style device. It is also desirable that the hinge assists a user in reaching the completion of a movement of the flip part toward the fully open or the fully closed positions.

Cost, simplicity, ease of assembly and small size are omnipresent concerns in the design and manufacture of hinges for flip-style devices. Another concern is the ability to separately manufacture the hinges as self-contained units that can be readily assembled to other components of flip-style devices.

### SUMMARY OF THE INVENTION

A self-contained hinge having a spring providing both torsional and compressive force is disclosed for use in any flip-style device. The hinge has a cam that receives an elongated shaft of a follower therethrough. A spring rotationally held relative to the cam and the elongated shaft compresses the cam and the follower together. Additionally, the spring applies a torsional force to the cam and follower.

### BRIEF DESCRIPTION OF THE DRAWINGS

Other features, objects and advantages will be apparent to those skilled in the art through reference to the detailed description and the drawings, of which:

FIG. 1 is a perspective view of a self-contained hinge in accordance with a preferred embodiment of the present invention;

FIG. 2 is a side view of a back side of the cam of FIG. 1;

FIG. 3 is a perspective view of an exemplary flip-style device in a fully closed position;

FIG. 4 is a perspective view of the flip-style device of FIG. 3 in a fully open position;

FIG. 5 is an exploded view of a self-contained hinge in accordance with a second preferred embodiment of the present invention;

FIG. 6 is an alternate exploded view of the self-contained hinge of FIG. 5;

FIG. 7A is a partial perspective view of the follower of the self-contained hinge of FIG. 5; and

FIG. 7B is a perspective view of the cam of the self-contained hinge of FIG. 5.

### DETAILED DESCRIPTION OF THE PREFERRED EMBODIMENTS

The invention is directed to a self-contained hinge having a follower configured to accept a cam on the follower. A spring provides compressive force to hold the cam against a cam surface of the follower and also provides torsional force to regulate relative rotational movement between the cam and the follower. In preferred embodiments, the cam and spring are configured to provide a self-opening and self-closing force after initial resistance to opening from a fully closed position and initial resistance to closing from a fully open position. To further illustrate these preferred broader aspects of the invention, preferred embodiments of the invention that include additional inventive features will now be discussed with reference to the drawings.

In general, PDA's and the like have a flip part and a main part that are connected to each other by a hinge. The hinge is often inserted through one of the parts, and then connected to the other part. Depending on the design construction, either the flip part or the main part may be formed to initially receive the hinge. The hinge regulates controlled movement between the flip part and the controlled part. In this manner, the flip-style device may be rotated from an open position to a closed position (i.e., an open-to-shut cycle) or vice-versa (i.e., a shut-to-open cycle). The hinge should also provide an initial resistance to rotation when the flip-style device is in the fully open position or the fully closed position.

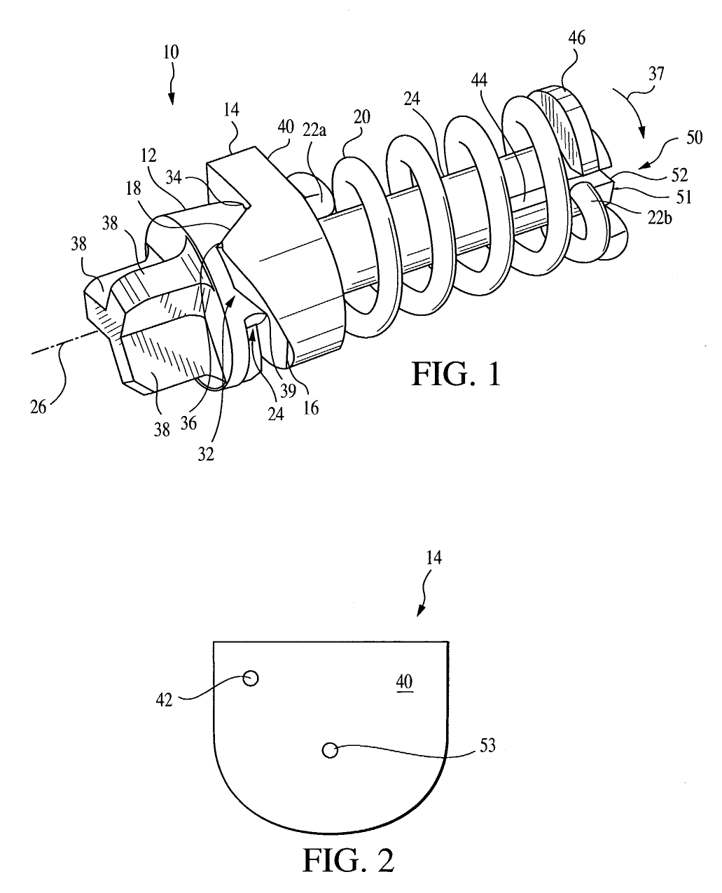

Turning now to the drawings, FIG. 1 illustrates a preferred embodiment self-contained hinge, generally designated 10. A follower 12 cooperates with a cam 14 that is axially aligned with and rides on the follower 12 such that a surface 16 of the cam mates with a follower surface 18 of the follower 12 under the influence of a compressive force supplied by a spring 20. The spring 20 also provides torsional forces to help regulate relative rotational movement between the follower 12 and the cam 14 and provide self-opening assistance. The spring 20 has an end 22a connected to the cam 14 such that the end 22a and the cam 14 rotate together. Another end 22b of the spring connects to an elongated shaft 24 of the follower 12 in a manner such that they rotate together. In other words, the spring 20 is rotationally held relative to the cam 14 and the follower 12. It is preferred that the spring 20 is rotationally fixed relative to both the cam 14 and the follower 12, but in no case may the spring 20 freely rotate with respect to either the cam 14 or the follower 12. The spring 20 may accordingly apply both torsional and compressive forces to the cam 14 and the follower 12 to effect relative rotation of the cam 14 to the follower 12 during the open-to-shut and shut-to open cycles of a flip-style device. Advantageously, the hinge 10 is self-contained, i.e., it can be fully assembled and later incorporated into a flip-style housing of a flip-style device. Optionally, a container (not shown) may be included to house the follower 12, cam 14, spring 20, and any other components of the hinge 10.

The formation of the hinge 10 as a self-contained unit that may be manufactured independently of other components of a flip-style device is a desirable feature of the hinge. This feature is advantageous because it allows manufacturers of flip-style devices to incorporate outside vendor's hinges in their devices. Additionally, these hinges can function in an entire flip-style product line to minimize a manufacturer's inventory of parts, and may be mass produced to reduce costs and be assembled with different manufacturers' products.

The cam 14 is rotatably and slidably coupled about the elongated shaft 24 to enable relative rotation of the follower 12 and the cam 14 about a longitudinal axis 26 and to allow the cam 14 limited axial movement along the elongated shaft 24. The cam 14 mechanically communicates with the follower 12. In general, the cam 14 and the follower 12 are shaped to rotate between defined positions, e.g., the fully open and the fully closed positions of the flip-style device. FIG. 1 illustrates the follower 12 rotated about the cam 14 to a cam closed position wherein the torsional force applied by the spring 20 is at a maximum, but insufficient to overcome the holding position supplied by a cam and follower interface 32, and in particular a ridge 34 of the follower 12 that is held against a peak 36 of the cam 14 in the closed position. At the cam closed position, the follower 12 can rotate relative to the cam 14 about the longitudinal axis 26 in a direction 37 when sufficient external force is provided.

The ridge 34 and peak 36 are configured to hold the cam 14 and follower 12 in the closed position of FIG. 1 by opposing the rotation force applied by the spring 20. An external force, e.g., as provided by a user of a flip-style device including the hinge 10 is necessary to move the hinge from the FIG. 1 closed position. The follower 12 has a device interface formed by three radially extending member 38 that can secure one end of the hinge 10 to a flip-style device.

The profile of the cam and follower interface 32 provides an initial resistance to rotation of the follower 12 in the direction of the arrow 37 upon application of an external rotational force. After overcoming the peak 36, the spring 20 automatically rotates the follower 12 to another ridge 39 that cooperates with the cam surface 16 and prevents further rotation of the follower 12. This defines a fully open position. The ridges 34, 39 define a profile or line of contact between the follower 12 and the cam 14. The specific design of the profile varies according to several factors, such as the dimensions of the cam 14 and the follower 12, and facilitates reduced contact stresses on the cam 14 and the follower 12 to limit wear and tear of these components. The profile of the cam and follower interface 32 further determines the angular position of the follower 12 relative to the cam 14 at which self-opening occurs. Preferably, the ridge 34 is designed to override the peak 36 of the cam 14 at about 15 degrees of relative cam/follower rotation from the FIG. 1 closed position. At this override point, the spring forces applied by the spring 20 will be independently sufficient to move the follower 12 relative the cam 14 until the ridge 39 is encountered. Thus, the spring 20 preferably applies an opening torque from the cam closed position that acts between 10-20 degrees and 165 degrees of relative rotation between the follower 12 and the cam 14.

The self-opening movement of the hinge 10 is primarily attributable to the rotational force of the spring 20. However, the compressive force will also assist rotation while the peak 36 rides down the ridge 34. The rotational force of the spring 20 will hold the follower 12 against the ridge 39, thereby holding the hinge 10 in an open position until a sufficient external force is applied to reverse movement back over the ridge 34 into the FIG. 1 position. During closing, once the peak 36 passes the ridge 34, compressive force of the spring 20 may provide some self-closing assistance. This will depend, however, on the relative amount of torsional force that opposes movement back to the fully closed FIG. 1 position. Preferably, the spring 20 applies a closing torque from the cam closed position that acts between 0 and 10-20 degrees of relative rotation between the follower 12 and the cam 14.

The detailed torque behavior of the cam 14 can be controlled by controlling the spring torque, spring compression and profile of the cam and follower interface 32. As will be appreciated by those skilled in the art, there are various parameters that have to be taken into consideration when determining the torsional and compressive properties of the combination of the spring 20, cam 14, and follower 12. These parameters include, for example, the profile of the cam 14, the initial torque required to begin rotation, the flip over angle, the angular range of rotation, the end torque required to complete rotation, and the flip over torque.

Compressive and rotational spring forces also effect the hinge “feel” in use, namely the resistance to opening and closing and the amount of self-opening force. These may be tailored to suit particular uses, for example by using different locations to secure the ends 22a, 22b of the spring 20.

The compression force “k” provided by the spring 20 must be sufficient to permit the cam and follower interface 32 to hold the closed position in opposition to the torsional force supplied by the spring 20. In other words, the torque attributable to the compressive force at the cam and follower interface 32 must exceed the torsional force of the spring 20 in the fully closed position by a certain value. This value determines the closing bias torque. For example, if a +35N-mm torque is desired on the closed position and the torsion spring gives −30N-mm torque at the closed position, then the cam and follower interface 32 and the force of compression should be such that it provides an initial torque of +65N-mm. A relatively low limit for the compression value ‘k’ for a spring 20 when it is also designed to function as a torsional spring requires a correspondingly steep interface to be provided by the ridge 34 and peak 36.

A back side 40 of the cam 14 is illustrated in FIG. 2. The preferred helical spring 20 encircles the elongated shaft 24 and has the axially parallel end 22a (relative to the longitudinal axis 26) inserted into a hole 42 of the back side 40 of the cam 14 to fix the spring 20 to the cam 14. The spring 20 has its other radially extending end 22b inserted into a longitudinal slot 44 of the follower 12 (FIG. 1). The hole 42 is preferably formed of a size and diameter to provide a close frictional fit. The slot 44 limits substantial movement of the end 22b to the longitudinal direction, permitting compression of the spring 20 during assembly. A retaining member, such as a C-clip or helical washer 46, which is attached to the elongated shaft 24 holds the spring 20 on the elongated shaft 24 and provides resistance to allow the spring 20 to exert the compressive force on the cam 14.

The preferred helical washer 46 prevents distortion of the spring 20 once the hinge 10 is assembled, and additionally may provide structural support to the hinge 10 upon insertion into a flip-style device. The helical washer 46 is positioned to minimize distortion of the spring 20 toward an end 50 of the elongated shaft 24. The end 50 includes a formation 51 to hold the washer 46. The formation 51 encircles only a portion of the circumference of the elongated shaft 24, permitting a gap 52 in the washer 46 to pass over the formation. The washer 46 is then turned slightly during assembly so that it abuts the formation 51. Alternative retaining members, e.g., cotter pins, may also be used in the present hinge 10 to assist with the compressing of the spring 20 against the cam 14 and/or preventing spring distortion.

As seen in FIG. 2, the cam 14 has an opening 53 that receives the elongated shaft 24 therethrough. The opening 53 and elongated shaft 24 are preferably smooth to reduce friction that would affect relative rotation and axial movement between the cam 14 and the follower 12. The opening 53 is preferably dimensioned, however, closely to the shaft 24 so that there is no significant radial movement of the cam 14.

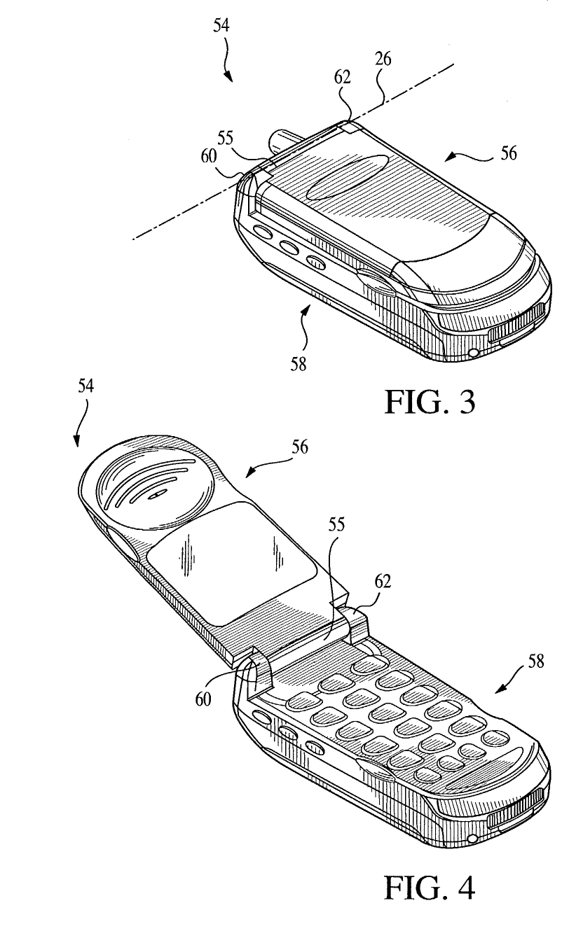

FIG. 3 shows a flip-style device, namely a cell phone 54 that incorporates the present hinge 10 of FIG. 1. Preferably, a hinge 10 is held at one of opposite ends of a hinge enclosure portion 55 of a flip part 56. It may also be desirable to have a hinge 10 at both ends of the enclosure portion 55, with two hinges acting cooperatively to control opening and closing of the flip part 56. The device interfaces of the hinges, e.g., radially extending members 38 lock into a pair of hinge holding ends 60, 62. Because the spring 20 and helical washer 46 may be compressed toward the cam 14, a fully assembled hinge 10 is easily inserted into the hinge enclosure portion 55. The spring 20 is compressed to permit joining of the flip part 56 and main part 58. Generally, the cell phone 54 is formed of two main components, a flip part 56 and a main part 58. The flip part 56 and the main part 58 rotate relative to one another about the longitudinal axis 26 of a hinge 10 held in the enclosure portion 55. The flip part 56 experiences a torsional force provided by internal components of the hinge 10, and automatically rotates to the fully open position upon a predetermined angle of rotation of the flip part about the longitudinal axis 26. The amount of torsional force applied by the internal components of the hinge 10 may be designed according to the dimensions and weight of the flip part 56.

FIG. 4 shows the cell phone 54 in a fully open position. The hinge 10 is at the open angle limit and maintains the flip part 56 in the fully open position.

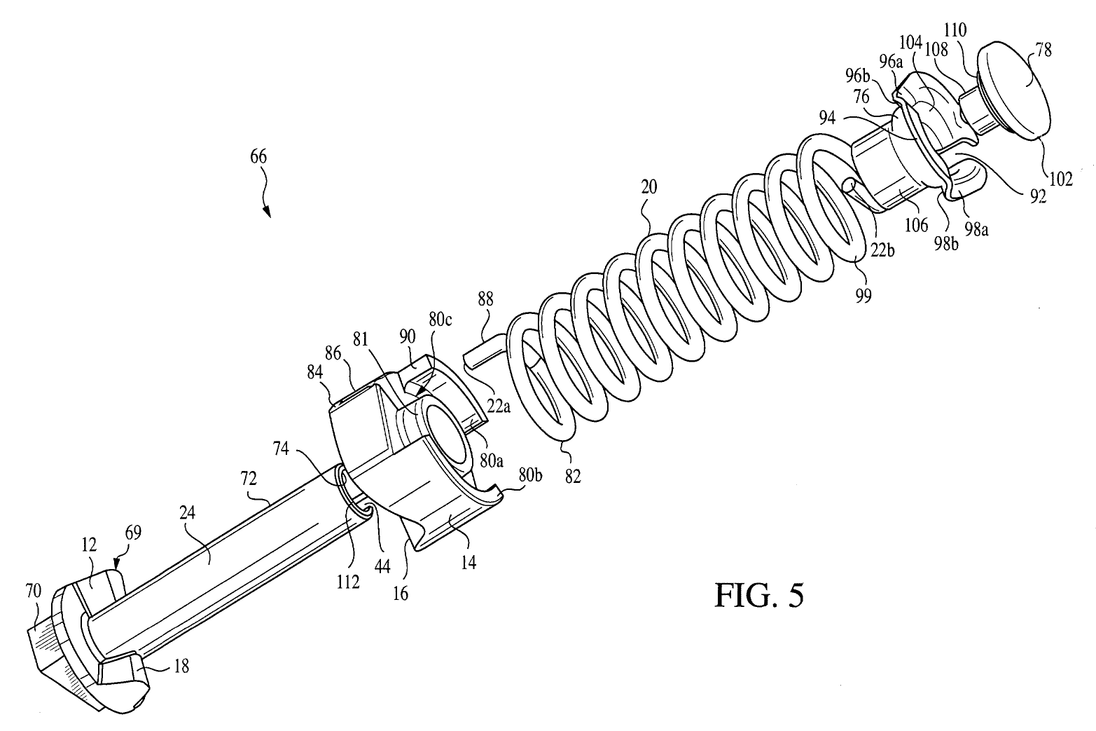

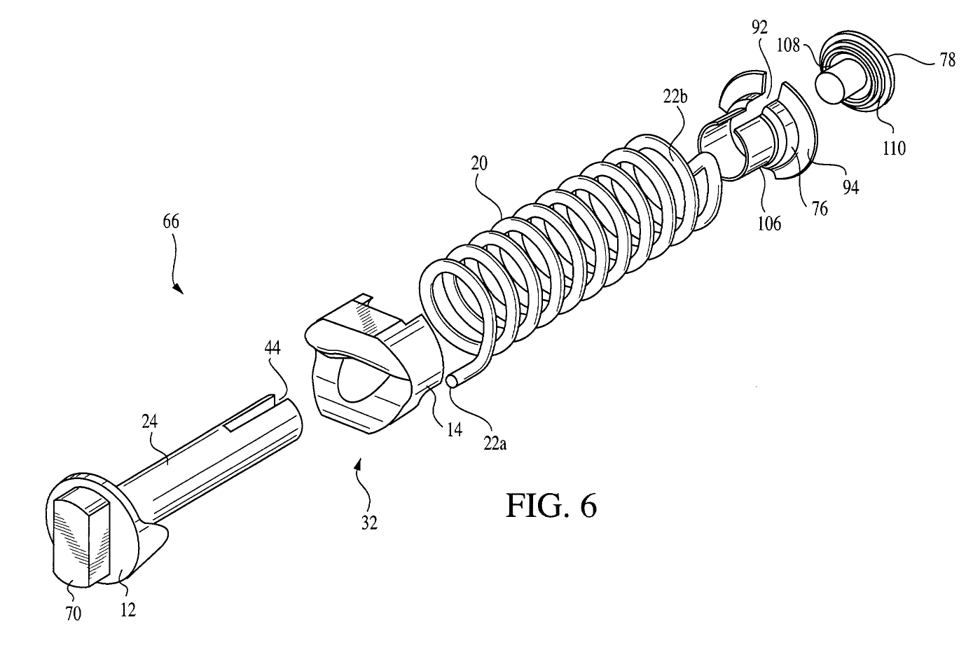

A second preferred embodiment of a self-contained hinge, generally designated 66, is illustrated in FIGS. 5-6 and has like components identified with identical reference numerals as used in FIG. 1. In the hinge 66, a device interface is formed by a single extending member 70 for engagement with a complimentary main part or flip part of a cell phone. The elongated shaft 24 of the follower 12 is generally hollow. It therefore defines an outer surface 72 and an inner surface 74, which serves to engage a retaining member formed by a collar 76 and a cap 78.

The cam 14 of the hinge 66 includes a pair of opposing seats 80a and 80b and a shaped seating area 80c that receive a first end turn 82 of the spring 20 upon assembly of the hinge 66. A cylindrical extension 81 extends within the spring 20 and fixes its position in the seating area 80c. An outer surface 84 of the cam 14 has a groove 86 to receive the end 22a of the spring 20. An end 88 of the spring 20 is also received by the groove 86 and further engages an end 90 of the seat 80a.

The collar 76 has a slot 92 extending through its entire length to accept the end 22b of the spring 20. The spring 20 is compressed by a flange 94. The flange 94 includes valleys 96a and 98a that create spring contact surfaces 96b and 98b. The valley 98a is deeper, thus extending the surface 98b further toward the cam than the surface 96b. This serves the same purpose as the helical shape of the preferred FIG. 1 washer, with the respective surfaces 96b and 98b pressing against different points of a second end turn 99 of the spring 20.

The cap 78 includes an outer rim 102 that seats on a ledge 104 of the collar 76. The interior diameter of the collar 76 is slightly larger than the elongated shaft 24 so a sleeve 106 slides over the outer surface 72. A cylinder 108 of the cap 78 slides within the elongated shaft 24 along its inner surface 74. A female snap fit formation 110 on the cap 78 snap fits to a male snap fit formation 112 on the shaft 24. When the snap fit is complete, the collar 76 is held by the outer rim 102. The flange 94 may be pressed by a flip-style device portion to permit the spring 20 to compress, thereby allowing the flange 94 and device interface 70 to move closer relative to one another to permit assembly into a flip-style device. The end 22b of the spring may move within the slot 92 during assembly.

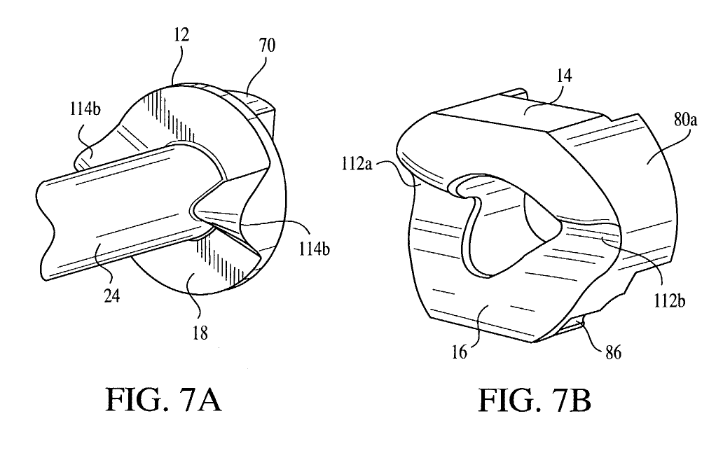

FIGS. 7A and 7B illustrate the cam surface 16 of the cam 14 and the follower surface 18 of the follower 12. The cam surface 16 mates with the follower surface 18 to form the cam and follower interface 32. The cam surface 16 has a profile defined by valleys 112a and 112b. These valleys 112a and 112b are engaged by peaks 114a and 114b of the follower 12 as the cam 14 rotates relative to the follower 12 between the fully open and fully closed positions of the hinge 66. As discussed with reference to the hinge 10 of FIG. 1, the specific design of the profile varies according to several factors and facilitates reduced contact stresses on the cam 14 and the follower 12 to limit wear and tear of these components.

While specific embodiments of the present invention have been shown and others described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A self-contained hinge for a flip-style device comprising:
a follower having an elongated shaft;
a cam receiving said elongated shaft therethrough; and
a spring rotationally held relative to said elongated shaft and said cam to compress said cam and said follower together and apply a torsional force to regulate relative movement of said cam and said follower.

2. The hinge of claim 1, wherein said cam includes a hole for receiving an end of said spring and fixing said spring to said cam.

3. The hinge of claim 2, wherein said elongated shaft includes a longitudinal slot for receiving an opposite end of said spring.

4. The hinge of claim 1, wherein said spring encircles said elongated shaft.

5. The hinge of claim 1, further comprising a retaining member connected to said elongated shaft to contact and prevent distortion of said spring.

6. The hinge of claim 5, wherein said elongated shaft has a formation at its end to hold said retaining member.

7. The hinge of claim 6, wherein said retaining member comprises a C-clip.

8. The hinge of claim 7, wherein said C-clip is helically shaped to match said spring.

9. The hinge of claim 1, wherein said follower has a surface defining open and closed positions of the hinge.

10. The hinge of claim 1, wherein said follower includes one or more extending members forming a device interface.

11. The hinge of claim 1, wherein said cam includes a seat area for receiving said spring.

12. The hinge of claim 11, wherein said cam includes an outer surface provided with a groove for receiving an end of said spring.

13. The hinge of claim 12, wherein said cam includes a cylindrical extension that extends within said spring.

14. The hinge of claim 5, wherein said retaining member includes a collar having a flange to press against said spring and a cap that seats in said collar and snap fits to said elongated shaft.

15. The hinge of claim 14, wherein said collar has a slit for receiving an end of said spring therethrough.

16. The hinge of claim 15, wherein flange includes at least two valleys to form a surface that presses against said spring.

17. The hinge of claim 16, wherein said collar includes a sleeve that slides over an outer surface of said elongated shaft.

18. The hinge of claim 17, wherein said elongated shaft includes an inner surface and said cap includes a cylinder that is received by said inner surface.

19. The hinge of claim 16, wherein said cap includes a female snap fit formation and an end of said elongated shaft includes a male snap fit formation.

20. A self-contained hinge for a flip-style device, comprising:
a cam with an opening;
a follower having a surface to mate with said cam and an elongated shaft extending away from said surface and through said opening; and
a spring having one end rotationally fixed to said elongated shaft and an opposite end rotationally fixed to said cam.

21. The hinge of claim 20, wherein said follower includes one or more extending members forming a device interface.

22. The hinge of claim 20, further comprising a retaining member for engaging said opposite end of said spring.

23. The hinge of claim 22, wherein said retaining member comprises a helical C-clip.

24. The hinge of claim 20, wherein said follower has a surface defining open and closed positions of the hinge.

25. The hinge of claim 24, wherein said surface of said follower includes a first ridge that overcomes a peak of a cam surface and a second ridge that engages said peak to prevent automatic rotation of said elongated shaft relative to said cam.

26. The hinge of claim 20, wherein said elongated shaft includes a longitudinal slot for receiving said end of said spring rotationally fixed to said elongated shaft.

27. The hinge of claim 22, wherein said retaining member includes a collar having a flange to press against said spring and a cap that seats in said collar and snap fits to said elongated shaft.

28. The hinge of claim 27, wherein said collar has a slot for receiving said end of said spring rotationally fixed relative to said elongated shaft.

29. The hinge of claim 27, wherein said flange includes at least two valleys to form a surface that presses against said spring.

30. The hinge of claim 22, wherein said cam includes a seat area for receiving said spring.

31. The hinge of claim 30, wherein said cam includes an outer surface provided with a groove for receiving said opposite end of said spring.

32. A self-contained hinge for a flip-style device comprising:
a cam mounted against a follower surface and around an elongated shaft extending away from said follower surface; and
a spring that simultaneously urges said cam against said follower surface and provides a torsional force that regulates relative rotation of said cam and said follower surface.

33. The hinge of claim 32, wherein said cam includes a groove for receiving one end of said spring.

34. The hinge of claim 33, wherein said elongated shaft includes a slot for receiving an opposite end of said spring.

35. The hinge of claim 32 formed as part of a flip-style device, and wherein a rotation of a flip part of the flip-style device of about 15 degrees from a closed position of the flip-style device enables a ridge of said follower surface to override a peak of a surface of said cam.

36. The hinge of claim 32, wherein said cam and said follower surface define fully closed, self-open and fully open positions relative to said cam.

37. The hinge of claim 32, wherein said cam includes a seat portion to seat said spring.

38. A flip-style device comprising:
a main part and flip part joined to permit rotation of said flip part with respect to said main part;
a hinge joining said main part and said flip part to permit said rotation of said flip part, said hinge including,
a follower having an elongated shaft;
a cam receiving said elongated shaft therethrough; and
a spring rotationally held relative to said elongated shaft and said cam to compress said cam against said follower and apply a torsional force to regulate relative movement of said follower and said cam.

39. The device of claim 38, wherein said hinge forms a separate unit that may be inserted into one of said main part and said flip part.

40. The device of claim 38, wherein said spring encircles said elongated shaft.

41. The device of claim 38, wherein said hinge further includes a retaining member connectable to said elongated shaft to engage said spring and prevent distortion thereof.

42. The device of claim 38, wherein said follower includes one or more extending members forming a device interface.

43. The device of claim 38, wherein said elongated shaft includes a longitudinal slot for receiving an end of said spring.
